(19) United States
(12) Patent Application Publication
(10) Pub. No.: US 2024/0257238 A1
(43) Pub. Date: Aug. 1, 2024

(54) MULTI-LEVEL BARTERING LOOP

(71) Applicants: Marián Seifert, Czech Republic (CZ); Jakub Kubica, Czech Republic (CZ)

(72) Inventors: Marián Seifert, Czech Republic (CZ); Jakub Kubica, Czech Republic (CZ)

(73) Assignee: OLOOPO s.r.o., Czech Republic (CZ)

(21) Appl. No.: 18/104,638

(22) Filed: Feb. 1, 2023

(51) Int. Cl. G06Q 40/04

(52) U.S. Cl. CPC G06Q 40/04

(57) ABSTRACT

A system for a multi-level bartering loop including a processor of a multi-level bartering loop server node. The processor is configured to receive a barter request comprising a selected item from the at least one user device; retrieve a record of the selected item from a pre-built graph table; place the record into a path vector and add the path vector to a queue; responsive to the queue being not empty, shift the path vector into a current path vector from the queue; load last item's reference from the current path vector and retrieve a record corresponding to the last item from the pre-built graph table; responsive to the record corresponding to the last item containing an accepted item, compare the accepted item to the selected item; and responsive to a match between the accepted item and the selected item, reverse the current path vector.

### TECHNICAL FIELD

This application generally relates to matching of users with other users for exchange of items, and more particularly, to an intelligent matching process facilitated by an automated assessment of the user's wished to exchange their items for items of other users.

### BACKGROUND

Whether users believe in bartering as an economic system, it is hard to argue with bartering efficiency. In the current monetary climate, fair value for products and services can vary from person to person. For example, although one user may think that a $30 yoga class is worth $20 to him, another person may think it is worth $50. By swapping goods and services and agreeing on an equal exchange of value, both parties are content and everyone wins. Also, cash works just fine for most of the users, cash is also susceptible to inflation while bartering offers a way to dodge the unexpected sharp price increases.

The trend in goods exchanges is growing. For example, a growing number of people are increasingly trading garden produce in exchange for goods and services. With food costs rising, local organic produce seems to increase rapidly in value and starting a garden can bring value home. For example, a woman may trade a batch of homemade tomato sauce in exchange for two hours' worth of house cleaning services and/or a yard clean-up or for bag of lemons, etc. A real estate agent may use fresh lemons from his backyard to secure a free car detail. The list goes on—i.e., gardeners need cleaning services, and houses need gardening care. By connecting supply with demand, users may get fresh organic fruits and vegetables from a backyard. The efficient bartering may have both ends covered. As, such community bartering organizations exist in local areas. However, the existing bartering organizations lack automated intelligent Internet-based bartering systems.

As such, what is needed is an effective solution for an intelligent matching process for matching users willing to barter their goods and services with other users facilitated by an automated assessment of the user goods/services and users bartering wishes using a multi-level bartering algorithm.

### SUMMARY

One example embodiment provides a system for implementation of a multi-level bartering loop including a processor of a multi-level bartering loop server node connected to a user device over a network and a memory on which are stored machine-readable instructions that when executed by the processor, cause the processor to: receive a barter request comprising a selected item from the at least one user device; retrieve a record of the selected item from a pre-built graph table; place the record into a path vector and add the path vector to a queue; responsive to the queue being not empty, shift the path vector into a current path vector from the queue, wherein the shift comprises load and remove first action; load last item's reference from the current path vector and retrieve a record corresponding to the last item from the pre-built graph table; responsive to the record corresponding to the last item containing at least one accepted item, compare the at least one accepted item to the selected item; and responsive to a match between the at least one accepted item and the selected item, reverse the current path vector.

Another example embodiment provides a method that includes one or more of: receiving a barter request comprising a selected item from the at least one user device; retrieving a record of the selected item from a pre-built graph table; placing the record into a path vector and add the path vector to a queue; responsive to the queue being not empty, shifting the path vector into a current path vector from the queue, wherein the shift comprises load and remove first action; loading last item's reference from the current path vector and retrieve a record corresponding to the last item from the pre-built graph table; responsive to the record corresponding to the last item containing at least one accepted item, comparing the at least one accepted item to the selected item; and responsive to a match between the at least one accepted item and the selected item, reversing the current path vector.

Yet another disclosed embodiment provides a non-transitory computer readable medium having instructions, that when read by a processor, cause the processor to perform: receiving a barter request comprising a selected item from the at least one user device; retrieving a record of the selected item from a pre-built graph table; placing the record into a path vector and add the path vector to a queue; responsive to the queue being not empty, shifting the path vector into a current path vector from the queue, wherein the shift comprises load and remove first action; loading last item's reference from the current path vector and retrieve a record corresponding to the last item from the pre-built graph table; responsive to the record corresponding to the last item containing at least one accepted item, comparing the at least one accepted item to the selected item; and responsive to a match between the at least one accepted item and the selected item, reversing the current path vector.

### BRIEF DESCRIPTION OF THE DRAWINGS

FIG. 1 illustrates an example of implementation of a multi-level bartering loop (MLBL) among three parties consistent with the disclosed embodiments;

FIG. 2 illustrates an example of implementation of the MLBL among five parties consistent with the disclosed embodiments;

FIG. 3 illustrates an example of implementation of the MLBL among n parties consistent with the disclosed embodiments;

FIG. 4 illustrates a path of acceptance consistent with the disclosed embodiments.

FIG. 5 illustrates another path of acceptance consistent with the disclosed embodiments.

FIG. 6 illustrates a flowchart of a graph table build-up process consistent with the disclosed embodiments.

FIG. 7 illustrates a flowchart of a process for finding the shortest MLBL consistent with the disclosed embodiments.

FIG. 8 illustrates a network diagram of a system for supporting a multi-level bartering loop consistent with the disclosed embodiments.

FIG. 9 illustrates an example blockchain-based network diagram of a system for supporting a multi-level bartering loop consistent with the disclosed embodiments.

FIG. 10 illustrates a network diagram of a system including detailed features of the MLBL server node consistent with the present disclosure.

FIG. 11 illustrates a flowchart of a method for implementing a multi-level bartering loop consistent with the present disclosure;

FIG. 12 illustrates a further flow chart of a method for implementing the multi-level bartering loop consistent with the present disclosure;

FIG. 13 illustrates a block diagram of a system including a computing device for performing the method of FIGS. 11 and 12.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

In addition, while the term “message” may have been used in the description of embodiments, the application may be applied to many types of networks and data. Furthermore, while certain types of connections, messages, and signaling may be depicted in exemplary embodiments, the application is not limited to a certain type of connection, message, and signaling.

Example embodiments provide methods, systems, components, non-transitory computer readable media, devices, and/or networks, which provide for intelligent matching process for implementing a multi-level bartering loop for matching users willing to barter their goods and/or services.

According to one disclosed embodiment, the exemplary matching system provides clients with an unparalleled personalized bartering experience. An Internet-based platform using the multi-level bartering loop server is provided. The multi-level bartering loop server may enable bartering users/customers to give one party what they ask for and in exchange get what they want from another party. The multi-level bartering loop exchange can be illustrated by the following embodiments discussed herein.

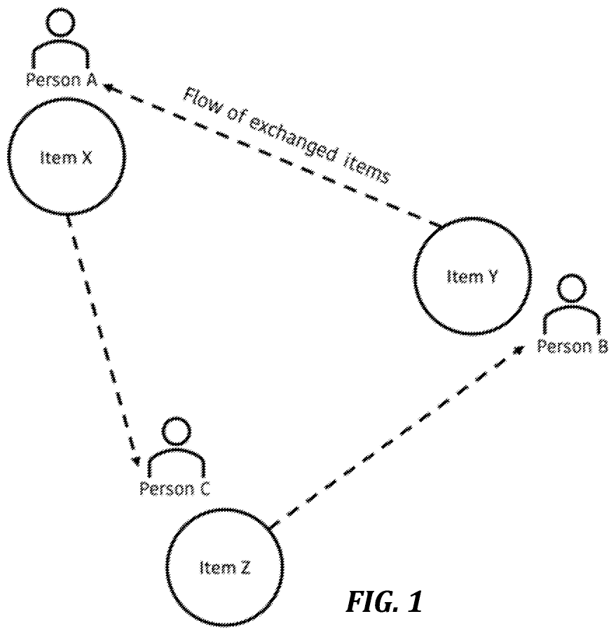

FIG. 1 illustrates an example of implementation of a multi-level bartering loop (MLBL) among three parties.

Referring to FIG. 1, a Person A offers item X and wants item Y, Person B offers item Y and wants item Z, Person C offers item Z and wants item X. The MLBL server node may connect these persons to exchange items in a multi-level loop. The MLBL can have anywhere between 2 and n parties.

According to the disclosed embodiments, a user may create an offer (i.e., an item, or multiple items under one listing). The user offer may indicate that the user may want to exchange these items and then accepts barter offers from other users. In case the user adds multiple listings, he may select his own listing that he may want to accept the offer with. Once the path of acceptances is created, the MLBL server node may search for a generated closed loop. The path of acceptance is a chain of items commencing with the selected item where every item is accepted by the preceding one.

Then, the users may either:
Be prompted to confirm to exchange what they offered for what they accepted, despite the fact that their offer may be transferred to a third party (in case there are more than 2 parties involved in the exchange); or
The exchange can be auto-approved, as the user may have already indicated their interest when he initially accepted the offer.

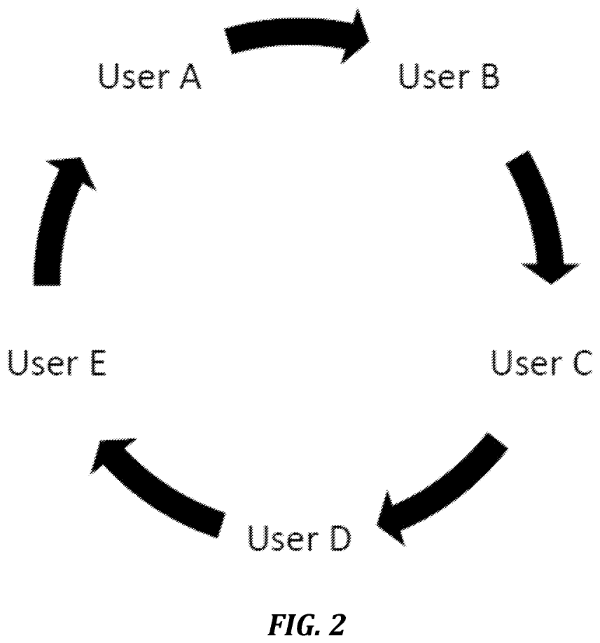

FIG. 2 illustrates an example of implementation of the MLBL among five parties.

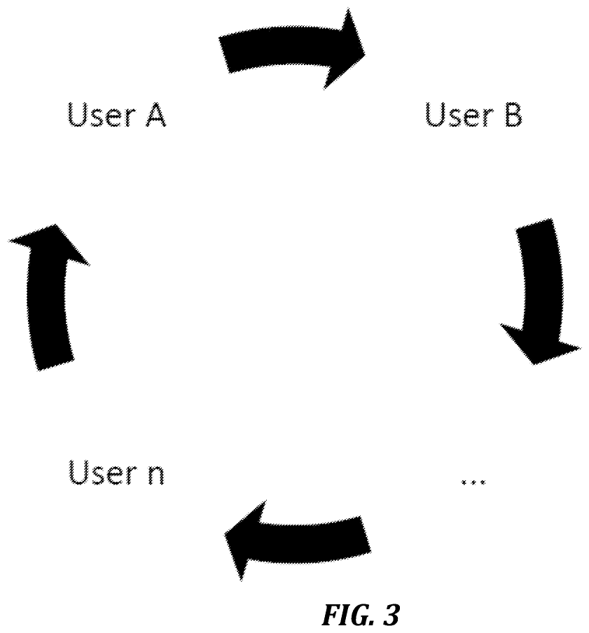

FIG. 3 illustrates an example of implementation of the MLBL among n parties.

Referring to FIG. 3, a singular exchange can happen between n users, as long as the loop is closed (each party offers something a preceding party desires).

According to the disclosed embodiments, the loop finding algorithm may be implemented in two steps:
The graph table build-up; and
The multilevel bartering loop algorithm.

According to the disclosed embodiments, the graph table build-up algorithm may be implemented by two approaches: using recursive and iterative method. The multi-level bartering loop algorithm follows the same process regardless of the approach. Both of these steps are required for the MLBL algorithm to work properly.

The graph table build-up may be implemented as follows. The graph table's goal is to find paths of acceptances for selected item. This may be implemented using directed graphs, mathematical structures used to model pairwise relations between objects.

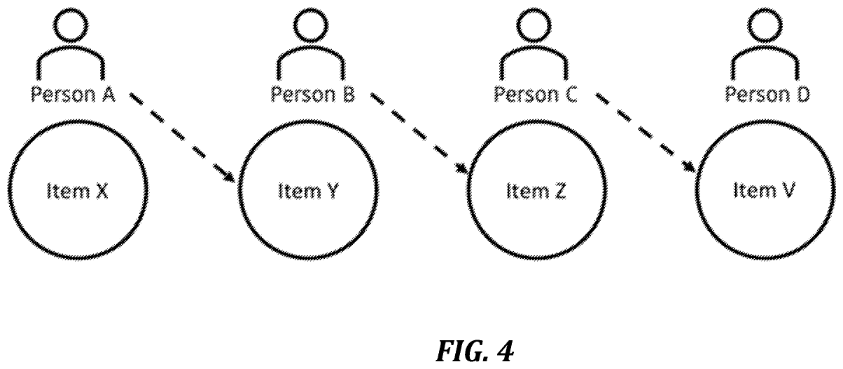

FIG. 4 illustrates a path of acceptance consistent with the disclosed embodiments.

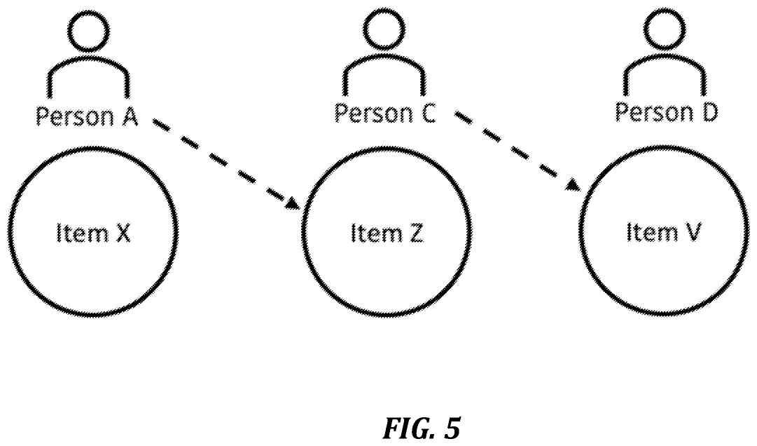

FIG. 5 illustrates another path of acceptance consistent with the disclosed embodiments.

FIG. 4 shows one path of acceptances. Users, their offer, and the item they desire. In case Person A would accept either Item Y, or Item Z, in exchange for Item X, at least 2 different paths of acceptances will be created (FIG. 4 and FIG. 5). Additional paths of acceptances would exist if Items Y, Z, or V would have accepted additional items than the ones showed in FIGS. 4 and 5. Paths of acceptance may or may not necessarily lead to a closed barter loop. For example, FIG. 4 and FIG. 5 illustrate the paths of acceptances that did not yet result in closed loops.

Before building the graph tables, the MLBL server node may determine the maximum number of parties that can exchange their items in one single exchange loop that may be referred to as a Level of loop or, for the purpose of building the GRAPH, the MAX_DEPTH. The graph tables may not be created for all items in the database (DB), but only for the selected ones. To become selected, the item may have accepted at least one new item (offered by any other user) for a potential exchange, since the last time the algorithm was run.

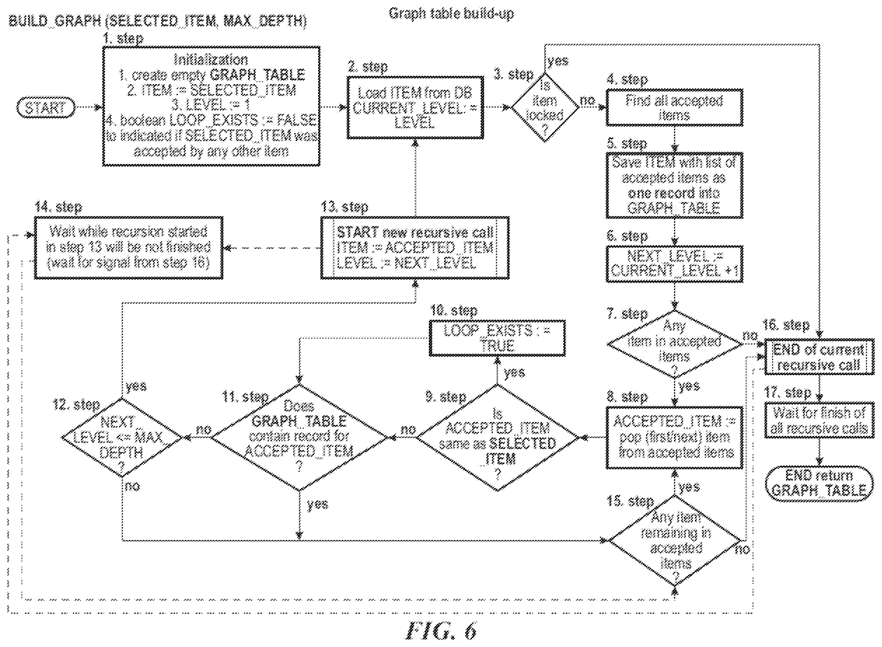

FIG. 6 illustrates a flowchart of a graph table build-up process consistent with the disclosed embodiments.

Referring to FIG. 6, the sentences like “owner of an item A accepted item B offered by another for an exchange” are replaced with “item A accepted item B”. For each selected item (SELECTED_ITEM), the algorithm may create data structure (GRAPH_TABLE) and may fill it with paths of acceptances—information about items accepted by the selected item (SELECTED_ITEM), then it may go one level deeper adding items accepted by items which had been accepted by the selected item, and then go deeper again, and again, until the maximum depth of graph (MAX_DEPTH parameter) is not reached, or no other items are left. Now the paths of acceptances for (SELECTED_ITEM) are complete and (GRAPH_TABLE) is finished. For every (SELECTED_ITEM) only one (GRAPH_TABLE) may be created.

The steps executed in the flowchart depicted in FIG. 6 are implemented as follows.

Step 1: Initialization of used variables.

GRAPH_TABLE: data structure that will be later filled with paths of acceptances starting with SELECTED_ITEM.

ITEM: indicates currently evaluated item. At the beginning it is referring to the SELECTED_ITEM, but as the recursions occur, other items within SELECTED_ITEM's paths of acceptances will get evaluated as well.

LEVEL: defines a current depth of the graph, or a number of parties involved in the exchange. At the beginning of the algorithm, the initial value of current level is set to 1 and increases as the graph deepens.

LOOP_EXISTS: Boolean flag indicating if SELECTED_ITEM itself was accepted by any other item within the path of acceptances. The flag begins with a false value.

Step 2:

Load ITEM from DB and set its CURRENT LEVEL to LEVEL.

Step 3:

Check if a current ITEM is for some reason in locked mode (e.g., the item is already participating in another exchange, or was exchanged, or is for any reason blocked or is under review).

Step 4: Find all items which have been accepted by the current ITEM.

Step 5: Put a record into GRAPH_TABLE. Record consists of ID of the current item and collection of its accepted items from previous Step 4.

Step 6: Calculate NEXT_LEVEL by incrementing value of CURRENT LEVEL.

Step 7: Check if collection of accepted items is empty or not.

Step 8: Pop (load and remove) item from collection of accepted items. Item is loaded for evaluation and removed from the collection of accepted items in order not to be evaluated again during this iteration of the algorithm.

Step 9: Test if the loaded ACCEPTED_ITEM is the same as SELECTED_ITEM. If positive, this means that the Multilevel Barter Loop exists.

Step 10: Set EXISTS_LOOP Boolean flag TRUE to be sure that the GRAPH_TABLE will contain data leading to at least one Multilevel Barter Loop.

Step 11: Test if the GRAPH_TABLE already contains record referring to loaded ACCEPTED_ITEM. If yes, the record will not be investigated again.

Step 12: Test if the NEXT_LEVEL will not reach limit set by MAX_DEPTH. In case it does not, the algorithm could execute another recursive call, where the items from the next level within the path of acceptance will be processed.

Step 13: Starting new recursive call (x+1). ITEM variable will refer to currently loaded ACCEPTED_ITEM, LEVEL is set to value of NEXT_LEVEL.

The algorithm will execute Step 2 with updated values of ITEM and LEVEL. Current recursion(x) will wait in Step 14, until the new recursive call is finished.

Step 14: Wait until recursion (x+1) started in step 13 is finished. Signal for continuing in current recursion(x) will come from step 16.

Transition from step 14 to step 15 will continue with values of ITEM, ACCEPTED_ITEM and NEXT_LEVEL from current recursion call. The same applies for collection of accepted items for current ITEM.

Step 15: Check collection of accepted items, if there are any items remaining to be evaluated. If yes, continue to step 8 where the next item is loaded. If the collection of accepted items is already empty, algorithm continues towards the Step 16, where the current recursion is terminated.

Step 16: Current recursion(x+1) is terminated. Signal is sent to Step 14 and the algorithm will continue in recursion(x) from previous level with previous setup as mentioned in Step 14.

Step 17: This is just a dummy step that says algorithm is waiting until all recursive calls are finished. As soon as all recursive calls in Step 16 are finished, the algorithm will return GRAPH_TABLE filled with all necessary relevant data to SELECTED_ITEM.

Note that when EXISTS_LOOP is not set to TRUE, it does not make sense to continue in 2nd part of the algorithm.

According to the disclosed embodiments, the shortest loop finding algorithm is implemented as follows. The purpose of this algorithm is to find the shortest multilevel barter loop between the SELECTED_ITEM and items collected in GRAPH_TABLE data structure from previous algorithm.

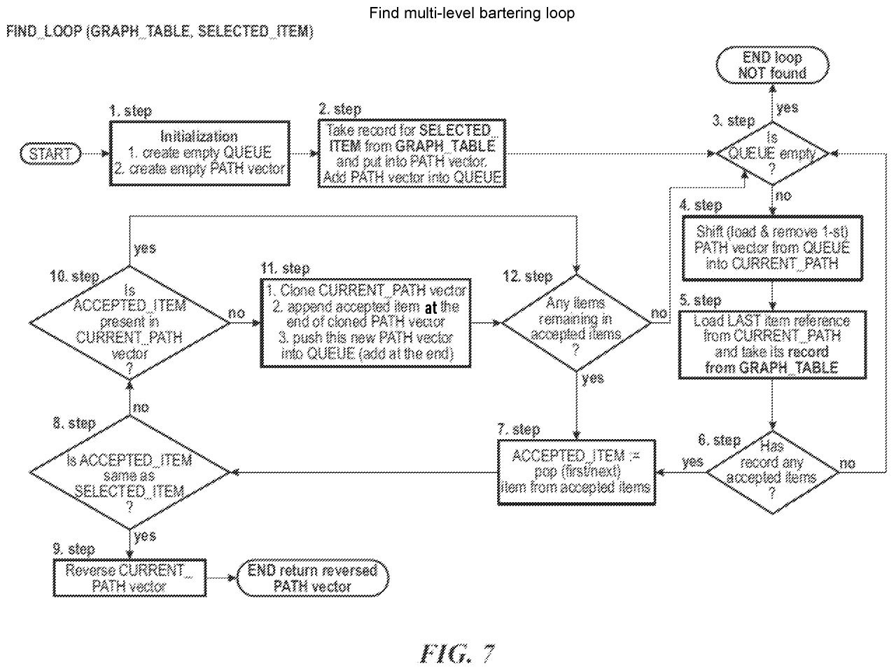

FIG. 7 illustrates a flowchart of a process for finding the shortest MLBL consistent with the disclosed embodiments.

Referring to FIG. 7, the steps executed in the flowchart depicted in FIG. 7 are implemented as follows.

Step 1: Initialization of used variables.

PATH or “path vector” represents an ordered array of item references from the path of acceptances. At the beginning at step 2, the PATH is prefilled with SELECTED_ITEM. As the algorithm is being executed, vector is gradually extended with additional accepted items, one by one from the path of acceptances. Every time when the PATH vector gets extended by another ACCEPTED_ITEM, current PATH is duplicated and ACCEPTED_ITEM is added at the end of the duplicated PATH.

QUEUE is another ordered array used as a temporary storage for all PATH vectors generated during the run of algorithm. At step 2: a reference of a SELECTED_ITEM's record from GRAPH_TABLE is inserted into the PATH vector. This PATH vector is added into the QUEUE as an initial record.

At step 3: the process may test if the QUEUE is empty. At first iteration it is logically non-empty because the QUEUE will contain initial vector inserted in the step 2. However, the QUEUE may get empty as the algorithm progresses. In such case, all PATH vectors have been processed, but none of them were able to reach the loop and the algorithm has finished with a void path.

At step 4: the PATH vector may be shifted (i.e., places as load and remove first) from the QUEUE.

At step 5: a reference of LAST item is acquired from the loaded PATH vector and the record given by this reference from GRAPH_TABLE is loaded.

At step 6: the process may test if the record loaded in step 5 contains non-empty collection of accepted items. If the record does not contain any accepted items, the process continues to the step 3 as there is nothing to examine. Otherwise, the process will continue to step 7.

At step 7: an item from collection of accepted items is popped (places as load and remove last) into the ACCEPTED_ITEM. This item becomes the current ACCEPTED_ITEM that will be examined in following steps.

At step 8: the process may test if the current ACCEPTED_ITEM is the same as SELECTED_ITEM. If true, the PATH vector leads to the loop in GRAPH_TABLE.

At step 9: the process may be terminated returning reversed PATH vector.

For example: when the PATH vector: A->B->C->A (Item A accepted item B, B accepted item C, C accepted A). Reversed PATH vector: C<-A<-B<-C (C item will be given to the owner of B item, B item will be given to the owner of A item, A item will be given to the owner of C item).

At step 10: the process may test if the current ACCEPTED_ITEM is already present in the CURRENT_PATH vector. If negative, the process may append the reference of the current ACCEPTED_ITEM to a new PATH vector in step 11. Otherwise, the process will continue to step 12 where the process continues into the next iteration with remaining accepted items.

At step 11: the process may append reference of the current ACCEPTED_ITEM to the path of acceptance, consisting of the following processes:
11.1 create a duplicate of the CURRENT_PATH vector that contains current path of acceptance;
11.2 push (add at the end of array) reference of ACCEPTED_ITEM at the end of the cloned PATH vector;
11.3 push (add at the end of array) the cloned and modified PATH vector into QUEUE.

At step 12: the process may check if collection of accepted items is empty. In case the collection is not empty, the process will continue to the step 7 where the next ACCEPTED_ITEM is loaded from the current GRAPH_TABLE record. In case the collection with accepted items was empty, the process returns to the step 3.

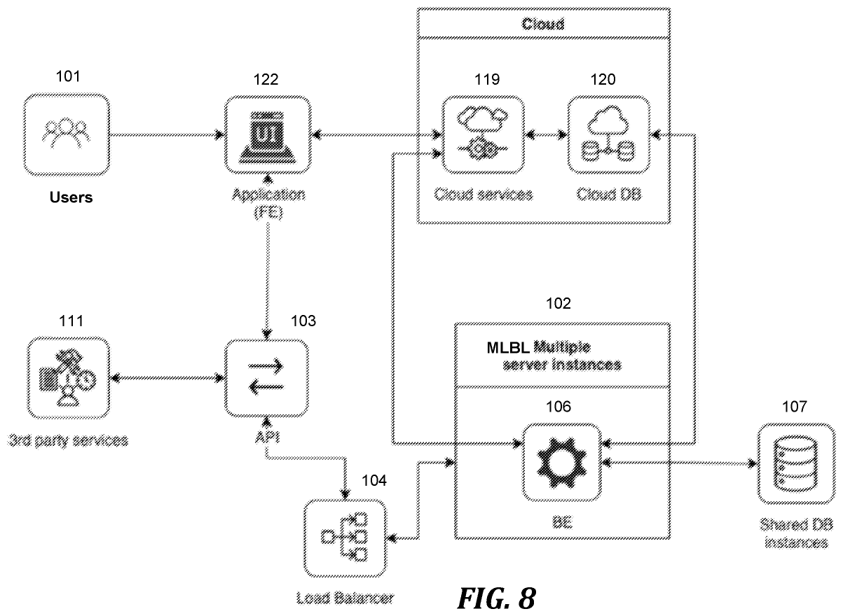

FIG. 8 illustrates a network diagram of a system for supporting a multi-level bartering loop consistent with the disclosed embodiments.

Referring to FIG. 8, users 101 may use user interface 122 for inputting ad receiving bartering data. An application programming interface (API) 103 may provide serving methods for accessing various backend services. A Load Balancer 104 represents a core networking solution configured to distribute traffic across group of multiple back-end servers 106 including the MLBL server node 102. The DB 107 instances may be shared across group of back-end servers 106 to ensure perfect data availability. Cloud may provide cloud services 119 that use cloud data from DB 120. The 3^{rd} party service(s) 111 may be provided by unaffiliated companies or other entities.

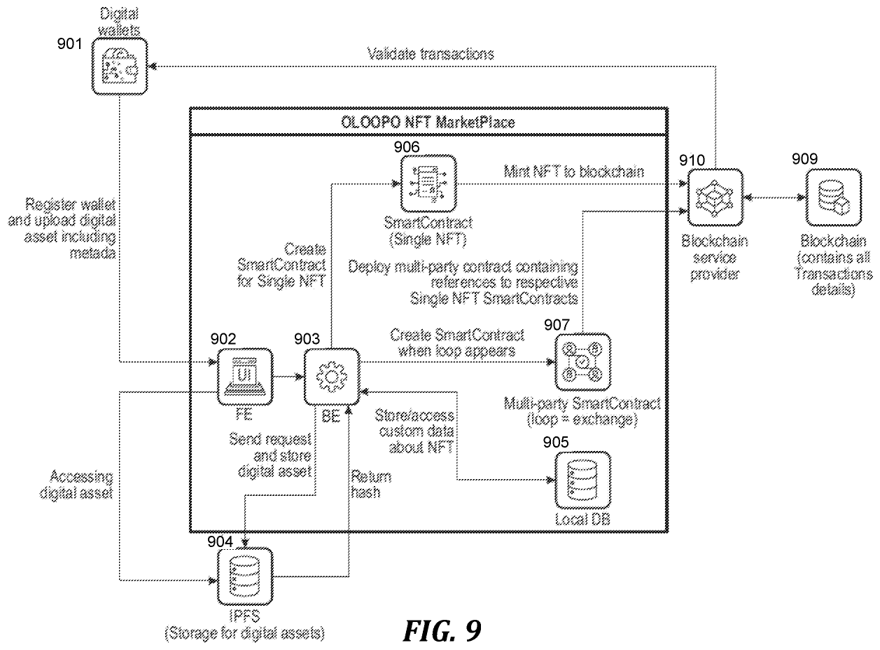

FIG. 9 illustrates an example blockchain-based network diagram of a system for supporting a multi-level bartering loop consistent with the disclosed embodiments.

Referring to FIG. 9, a barter loop for NFT market place architecture may be implemented. In one embodiment, the multi-level bartering loop can also be used for the exchange of any blockchain-based digital assets, within a dedicated marketplace utilizing blockchain technology.

In another embodiment, the barter loop may be implemented using a decentralized storage such as a blockchain ledger 109 that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records and no single peer can modify the records without a consensus being reached among the distributed peers. For example, the blockchain peers may execute a consensus protocol to validate blockchain storage transactions, group the storage transactions into blocks, and build a hash chain over the blocks. This process forms the ledger by ordering the storage transactions, as is necessary, for consistency. In various embodiments, a permissioned and/or a permissionless blockchain can be used. In a public or permissionless blockchain, anyone can participate without a specific identity. Public blockchains can involve assets and use consensus based on various protocols such as Proof of Work (PoW). On the other hand, a permissioned blockchain provides secure interactions among a group of entities which share a common goal such as storing card usage recommendation parameters for efficient usage of the payment cards, but which do not fully trust one another.

This application may utilize a permissioned (private) blockchain that operates arbitrary, programmable logic, tailored to a decentralized storage scheme and referred to as “smart contracts” or “chaincodes.” In some cases, specialized chaincodes may exist for management functions and parameters which are referred to as system chaincodes. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After a validation, the transactions enter an ordering phase in which a consensus protocol is used to produce an ordered sequence of endorsed transactions grouped into blocks.

The example system depicted in FIG. 9 may include but not be limited to the following elements. Digital wallet 901 represents an online service to store digital funds. Frontend FE 902 represents a user interface of marketplace application. Backend BE 903 is configured to performing operations required for minting NFTs. IPFS 904 is a distributed system for storing and accessing files, websites, applications. It is designed to work together with existing blockchain protocols. Local DB 905 is a database for storing and accessing custom data reflecting information about NFTs minted by marketplace application. Smart Contract 906 (single NFT) is a self-executing code stored on a blockchain that runs when predetermined conditions are met Multi-party Smart Contract 907 is a kind of the smart contract interacting with existing deployed contracts 906 for single NFTs. Blockchain service provider 908 is a service providing access to the blockchain. Blockchain ledger 909 is a distributed database that stores information about NFT transactions and NFT exchange transactions withing the barter loop.

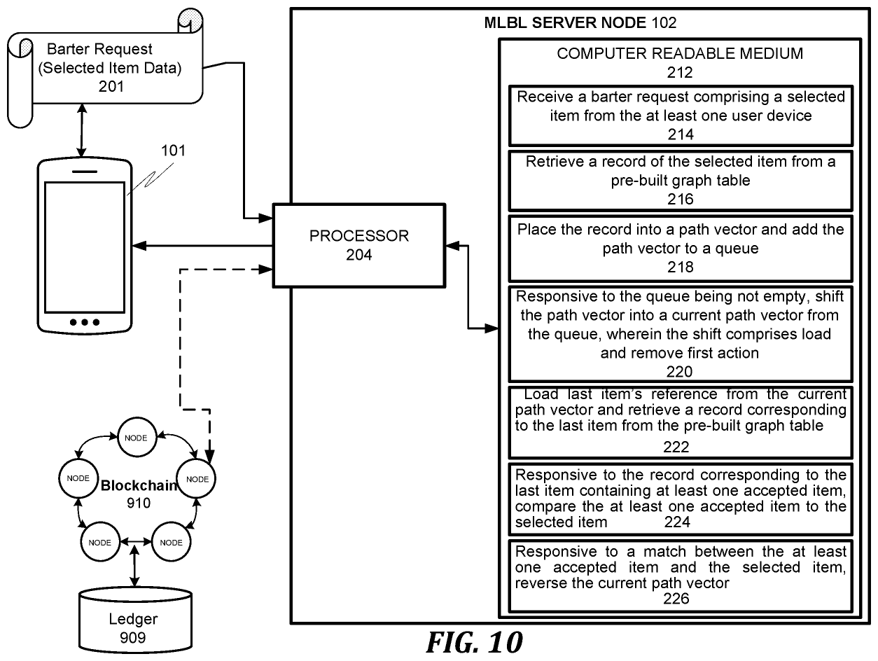

FIG. 10 illustrates a network diagram of a system including detailed features of a MLBL server node consistent with the present disclosure.

Referring to FIG. 10, the example network includes the MLBL server node 102 connected to user device(s) 101 over a network or over a blockchain 910. The user device 101 may generate a barter request 201 including a selected item the user of the device 101 intends to barter. The barter request may include items acceptable for the barter. As discussed above, the barter items may be represented by NFTs being bartered over the blockchain 910 while the records may be stored on the ledger 909.

While this example describes in detail only one MLBL server node 102, multiple such nodes may be connected to the network and to the blockchain 910. It should be understood that the MLBL server node 102 may include additional components and that some of the components described herein may be removed and/or modified without departing from a scope of the MLBL server node disclosed herein. The MLBL server node may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the MLBL server node may include multiple processors, multiple cores, or the like, without departing from the scope of the MLBL server node system.

The MLBL server node may also include a non-transitory computer readable medium 212 that may have stored thereon machine-readable instructions executable by the processor 204. Examples of the machine-readable instructions are shown as 214-226 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to receive a barter request comprising a selected item from the at least one user device 101. The processor 204 may fetch, decode, and execute the machine-readable instructions 216 to retrieve a record of the selected item from a pre-built graph table. The processor 204 may fetch, decode, and execute the machine-readable instructions 218 to place the record into a path vector and add the path vector to a queue. The processor 204 may fetch, decode, and execute the machine-readable instructions 220 to, responsive to the queue being not empty, shift the path vector into a current path vector from the queue, wherein the shift may include load and remove first action.

The processor 204 may fetch, decode, and execute the machine-readable instructions 222 to load last item's reference from the current path vector and retrieve a record corresponding to the last item from the pre-built graph table. The processor 204 may fetch, decode, and execute the machine-readable instructions 224 to, responsive to the record corresponding to the last item containing at least one accepted item, compare the at least one accepted item to the selected item. The processor 204 may fetch, decode, and execute the machine-readable instructions 226 to, responsive to a match between the at least one accepted item and the selected item, reverse the current path vector. The blockchain 910 may be configured to use one or more smart contracts that manage transactions for multiple participating nodes and for recording the transactions on the ledger 909.

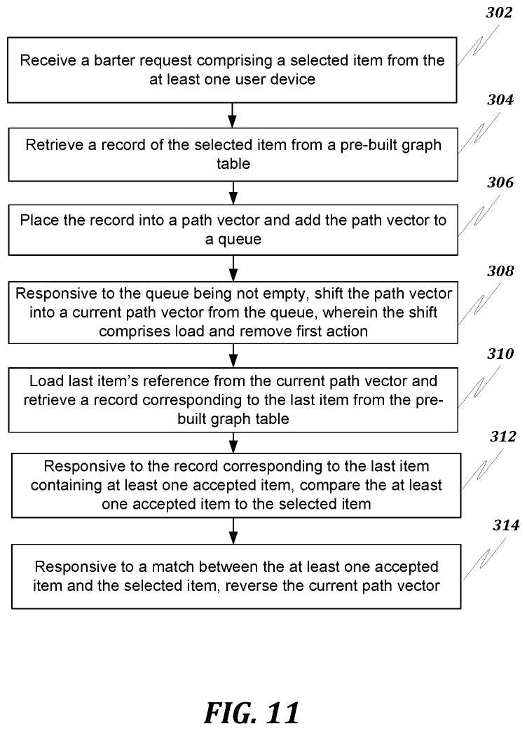

FIG. 11 illustrates a flowchart of a method for implementing a multi-level bartering loop consistent with the present disclosure.

Referring to FIG. 11, the method may include one or more of the steps described below. FIG. 11 illustrates a flow chart of an example method executed by the MLBL server node 102 (see FIG. 10). It should be understood that method depicted in FIG. 11 may include additional operations and that some of the operations described therein may be removed and/or modified without departing from the scope of the disclosed method. The description of the disclosed method is also made with reference to the features depicted in FIG. 10 for purposes of illustration. Particularly, the processor 204 of the MLBL server node 102 may execute some or all of the operations included in the disclosed method.

With reference to FIG. 11, at block 302, the processor 204 may receive a barter request comprising a selected item from the at least one user device. At block 304, the processor 204 may retrieve a record of the selected record item from a pre-built graph table. At block 306, the processor 204 may place the into a path vector and add the path vector to a queue. At block 308, the processor 204 may responsive to the queue being not empty, shift the path vector into a current path vector from the queue, wherein the shift comprises load and remove first action. At block 310, the processor 204 may load last item's reference from the current path vector and retrieve a record corresponding to the last item from the pre-built graph table. At block 312, the processor 204 may, responsive to the record corresponding to the last item containing at least one accepted item, compare the at least one accepted item to the selected item. At block 314, the processor 204 may, responsive to a match between the at least one accepted item and the selected item, reverse the current path vector.

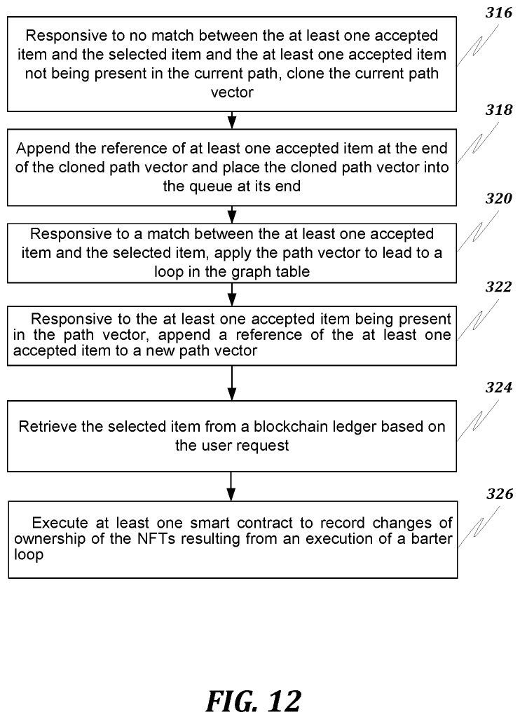

FIG. 12 illustrates a further flowchart of a method for implementing the multi-level bartering loop consistent with the present disclosure. Referring to FIG. 12, the method may include one or more of the steps described below. FIG. 12 illustrates a flow chart of an example method executed by the MLBL server node 102 (see FIG. 10). It should be understood that method depicted in FIG. 12 may include additional operations and that some of the operations described therein may be removed and/or modified without departing from the scope of the disclosed method. The description of the disclosed method is also made with reference to the features depicted in FIG. 10 for purposes of illustration. Particularly, the processor 204 of the MLBL server node 102 may execute some or all of the operations included in the disclosed method.

With reference to FIG. 12, at block 316, the processor 204 may, responsive to no match between the at least one accepted item and the selected item and the at least one accepted item not being present in the current path, clone the current path vector. At block 318, the processor 204 may append the at least one accepted item at the end of the cloned path vector and place the cloned path vector into the queue at its end. At block 320, the processor 204 may, responsive to a match between the at least one accepted item and the selected item, apply the path vector to lead to a loop in the graph table. At block 322, the processor 204 may, responsive to the at least one accepted item being present in the path vector, append a reference of the at least one accepted item to a new path vector.

At block 324, the processor 204 may retrieve the selected item from a blockchain ledger based on the user request. The selected item and the at least one accepted item may comprise NFTs recorded on the blockchain ledger. At block 326, the processor 204 may execute at least one smart contract to record changes of ownership of the NFTs resulting from an execution of a barter loop.

The above embodiments of the present disclosure may be implemented in hardware, in a computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

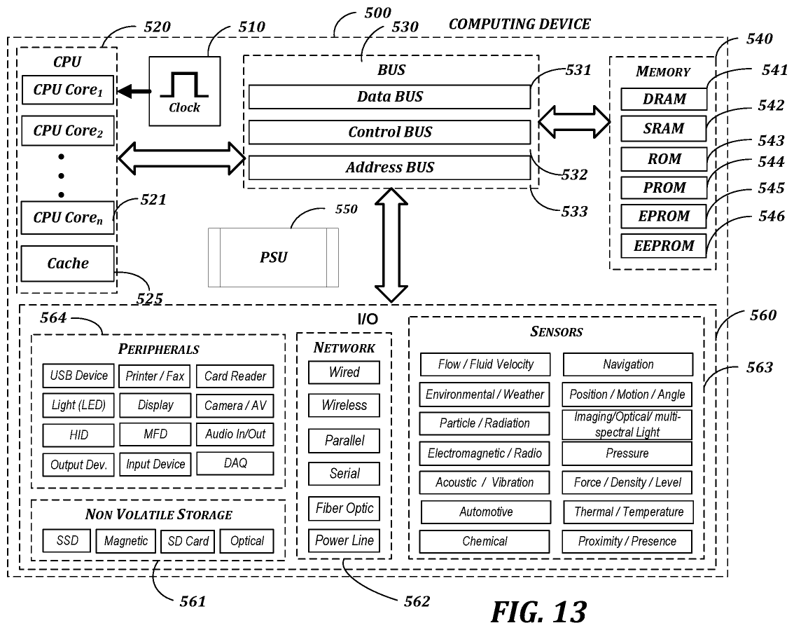

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 13 illustrates an example computing device 500 (e.g., the MLBL server node 102), which may represent or be integrated in any of the above-described components, etc.

FIG. 13 illustrates a block diagram of a system including computing device 500. The computing device 500 may comprise, but not be limited to the following:

Mobile computing device, such as, but is not limited to, a laptop, a tablet, a smartphone, an augmented reality device, a virtual reality device, mixed reality device, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS500/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server (laptop or notebook), wherein a server may be rack mounted, a workstation, an industrial device, a raspberry pi, a desktop, or an embedded device;

The MLBL server node 102 (see FIG. 10) may be hosted on a centralized server or on a cloud computing service or servers in clusters. Although method 300 has been described to be performed by the MLBL server node 102 implemented on a computing device 500, it should be understood that, in some embodiments, different operations may be performed by a plurality of the computing devices 500 in operative communication at least one network.

Embodiments of the present disclosure may comprise a computing device having a central processing unit (CPU) 520, a bus 530, a memory unit 550, a power supply unit (PSU) 550, and one or more Input/Output (I/O) units. The CPU 520 coupled to the memory unit 550 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages any method disclosed herein.

Consistent with an embodiment of the disclosure, the aforementioned CPU 520, the bus 530, the memory unit 550, a PSU 550, and the plurality of I/O units 560 may be implemented in a computing device, such as computing device 500. Any suitable combination of hardware, software, or firmware may be used to implement the aforementioned units. For example, the CPU 520, the bus 530, and the memory unit 550 may be implemented with computing device 500 or any of other computing devices 500, in combination with computing device 500. The aforementioned system, device, and components are examples and other systems, devices, and components may comprise the aforementioned CPU 520, the bus 530, the memory unit 550, consistent with embodiments of the disclosure.

At least one computing device 500 may be embodied as any of the computing elements illustrated in all of the attached figures, including the RS node 102 (FIG. 2). A computing device 500 does not need to be electronic, nor even have a CPU 520, nor bus 530, nor memory unit 550. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 13, a system consistent with an embodiment of the disclosure may include a computing device, such as computing device 500. In a basic configuration, computing device 500 may include at least one clock module 510, at least one CPU 520, at least one bus 530, and at least one memory unit 550, at least one PSU 550, and at least one I/O 560 module, wherein I/O module may be comprised of, but not limited to a non-volatile storage sub-module 561, a communication sub-module 562, a sensors sub-module 563, and a peripherals sub-module 565.

A system consistent with an embodiment of the disclosure the computing device 500 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 5 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 550 or input/output 560). Some embodiments of the clock 510 may include dynamic frequency change, where, the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical CPU cores 521, such as, but not limited to, homogeneous multi-core systems. It is also possible for the plurality of CPU cores 521 to comprise different CPU cores 521, such as, but not limited to, heterogeneous multi-core systems, big. LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 550, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/105 bus (e.g., PC/105-Plus, PCI/105-Express, PCI/105, and PCI-105), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1395 Interface/Firewire, Thunderbolt, and extensible Host Controller Interface (xHCI).

Consistent with the embodiments of the present disclosure, the aforementioned computing device 500 may employ hardware integrated circuits that store information for immediate use in the computing device 500, know to the person having ordinary skill in the art as primary storage or memory 550. The memory 550 operates at high speed, distinguishing it from the non-volatile storage sub-module 561, which may be referred to as secondary or tertiary storage, which provides slow-to-access information but offers higher capacities at lower cost. The contents contained in memory 550, may be transferred to secondary storage via techniques such as, but not limited to, virtual memory and swap. The memory 550 may be associated with addressable semiconductor memory, such as integrated circuits consisting of silicon-based transistors, used for example as primary storage but also other purposes in the computing device 500. The memory 550 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 551, Static Random-Access Memory (SRAM) 552, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 553, Programmable ROM (PROM) 555, Erasable PROM (EPROM) 555, Electrically Erasable PROM (EEPROM) 556 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 565. The plurality of hardware is used by the at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).
Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using intermediate area in the memory 550. The non-volatile storage sub-module 561 does not lose data when power is removed and may be two orders of magnitude less costly than storage used in memory module, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be said are networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 5 [IPv5], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]) or 3G, 4G, 5G.

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand or fiber cable.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 5G (such as WiMax and LTE), and 5G (short and long wavelength).
Parallel communications, such as, but not limited to, LPT ports.
Serial communications, such as, but not limited to, RS-232 and USB (all versions).
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (02), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermos-luminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photo switch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezo-capacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 565 comprises ancillary devices uses to put information into and get information out of the computing device 500. There are 3 categories of devices comprising the peripheral sub-module 565, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 565:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual and augmented reality systems.
Video Input devices are used to digitize images or video from the outside world into the computing device 500. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
Data Acquisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 562 sub-module), data storage device (non-volatile storage 561), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

What is claimed is:

1. A system, comprising:
a processor of a multi-level bartering loop (MLBL) server node connected to at least one user device over a network;
a memory on which are stored machine-readable instructions that when executed by the processor, cause the processor to:
receive a barter request comprising a selected item from the at least one user device;
retrieve a record of the selected item from a pre-built graph table;
place the record into a path vector and add the path vector to a queue;
responsive to the queue being not empty, shift the path vector into a current path vector from the queue, wherein the shift comprises load and remove first action;
load last item's reference from the current path vector and retrieve a record corresponding to the last item from the pre-built graph table;
responsive to the record corresponding to the last item containing at least one accepted item, compare the at least one accepted item to the selected item; and
responsive to a match between the at least one accepted item and the selected item, reverse the current path vector.

2. The system of claim 1, wherein the instructions further cause the processor to, responsive to no match between the at least one accepted item and the selected item and the at least one accepted item not being present in the current path, clone the current path vector.

3. The system of claim 2, wherein the instructions further cause the processor to append the at least one accepted item at the end of the cloned path vector and place the cloned path vector into the queue at its end.

4. The system of claim 1, wherein the instructions further cause the processor to, responsive to a match between the at least one accepted item and the selected item, apply the path vector to lead to a loop in the graph table.

5. The system of claim 1, wherein the instructions further cause the processor to, responsive to the at least one accepted item being present in the path vector, append a reference of the at least one accepted item to a new path vector.

6. The system of claim 1, wherein the instructions further cause the processor to retrieve the selected item from a blockchain ledger based on the user request.

7. The system of claim 6, wherein the selected item and the at least one accepted item comprise NFTs recorded on the blockchain ledger.

8. The system of claim 7, wherein the instructions further cause the processor to execute at least one smart contract to record changes of ownership of the NFTs resulting from an execution of a barter loop.

9. A method for implementation of a multi-level bartering loop, comprising:
receiving, by a multi-level bartering loop (MLBL) server node, a barter request comprising a selected item from at least one user device;
retrieving, by the MLBL server node, a record of the selected item from a pre-built graph table;
placing, by the MLBL server node, the record into a path vector and adding the path vector to a queue;
responsive to the queue being not empty, shifting, by the MLBL server node, the path vector into a current path vector from the queue, wherein the shift comprises load and remove first action;
loading, by the MLBL server node, last item's reference from the current path vector and retrieving a record corresponding to the last item from the pre-built graph table;
responsive to the record corresponding to the last item containing at least one accepted item, comparing, by the MLBL server node, the at least one accepted item to the selected item; and
responsive to a match between the at least one accepted item and the selected item, reversing the current path vector by the MLBL server node.

10. The method of claim 9, further comprising, responsive to no match between the at least one accepted item and the selected item and the at least one accepted item not being present in the current path, cloning the current path vector.

11. The method of claim 10, further comprising appending the at least one accepted item at the end of the cloned path vector and placing the cloned path vector into the queue at its end.

12. The method of claim 9, further comprising, responsive to a match between the at least one accepted item and the selected item, applying the path vector to lead to a loop in the graph table.

13. The method of claim 9, further comprising, responsive to the at least one accepted item being present in the path vector, appending a reference of the at least one accepted item to a new path vector.

14. The method of claim 9, further comprising retrieving the selected item from a blockchain ledger based on the user request.

15. The method of claim 14, wherein the selected item and the at least one accepted item comprise NFTs recorded on the blockchain ledger.

16. The method of claim 15, further comprising execute at least one smart contract to record changes of ownership of the NFTs resulting from an execution of a barter loop.

17. A non-transitory computer readable medium comprising instructions, that when read by a processor, cause the processor to perform:
receiving a barter request comprising a selected item from at least one user device;
retrieving a record of the selected item from a pre-built graph table;
placing the record into a path vector and adding the path vector to a queue;
responsive to the queue being not empty, shifting the path vector into a current path vector from the queue, wherein the shift comprises load and remove first action;
loading last item's reference from the current path vector and retrieving a record corresponding to the last item from the pre-built graph table;
responsive to the record corresponding to the last item containing at least one accepted item, comparing the at least one accepted item to the selected item; and
responsive to a match between the at least one accepted item and the selected item, reversing the current path vector.

18. The non-transitory computer readable medium of claim 17, further comprising instructions, that when read by the processor, cause the processor to, responsive to no match between the at least one accepted item and the selected item and the at least one accepted item not being present in the current path, clone the current path vector.

19. The non-transitory computer readable medium of claim 18, further comprising instructions, that when read by the processor, cause the processor to append the at least one accepted item at the end of the cloned path vector and place the cloned path vector into the queue at its end.

20. The non-transitory computer readable medium of claim 17, further comprising instructions, that when read by the processor, cause the processor to, responsive to a match between the at least one accepted item and the selected item, apply the path vector to lead to a loop in the graph table.
